(19) United States
(12) Patent Application Publication
(10) Pub. No.: US 2024/0378276 A1
(43) Pub. Date: Nov. 14, 2024

(54) AUTHENTICATION TERMINAL, SYSTEM, CONTROL METHOD OF AUTHENTICATION TERMINAL, AND STORAGE MEDIUM

(71) Applicant: NEC Corporation, Minato-ku, Tokyo (JP)

(72) Inventor: Daisuke KAWASAKI, Tokyo (JP)

(73) Assignee: NEC Corporation, Minato-ku, Tokyo (JP)

(21) Appl. No.: 18/691,519

(22) PCT Filed: Sep. 30, 2021
(86) PCT No.: PCT/JP2021/036186

§ 371 Date: Mar. 13, 2024

(51) Int. Cl. G06F 21/32; H04L 9/40

(52) U.S. Cl. CPC G06F 21/32; H04L 63/08

(57) ABSTRACT

An authentication terminal includes a first acquisition unit, a second acquisition unit, a control unit, and an authentication processing unit. The first acquisition unit acquires first biometric information of a user from another apparatus when a distance between own terminal and the user reaches a first distance. The second acquisition unit acquires second biometric information of the user when the distance between own terminal and the user reaches a second distance. The control unit performs control to acquire data for authentication from a terminal possessed by the user, which is necessary to determine whether or not to provide a service to the user. The authentication processing unit determines that an authentication processing of the user is successful when a result of the matching processing using the first biometric information and the second biometric information is successful and the data for authentication acquired from the terminal is valid.

### TECHNICAL FIELD

The present invention relates to an authentication terminal, a system, a control method of an authentication terminal, and a storage medium.

### BACKGROUND ART

Patent Literature 1 discloses a mobile phone in which a contactless card is implemented and stores data such as ticket reservation information, commuter passes, and so on. The mobile phone transmits the above stored data to an automatic gate installed at a station or the like. The automatic gate transmits the acquired data to a server, and the server verifies the received data. If the verified data is normal, the automatic gate permits a user to pass through.

### CITATION LIST

### Patent Literature

[PTL 1] Japanese utility model registration No. 3076212

### SUMMARY OF INVENTION

### Technical Problem

In Patent Literature 1, information required to pass through the automatic gate is transmitted from the mobile phone to the automatic gate. Here, if a function assigned to the automatic gate is unchanged, it is sufficient that predetermined data is transmitted from the mobile phone to the automatic gate. However, if data for passing through the automatic gate changes depending on a location where the automatic gate is installed or a period of time when the automatic gate operates, and so on, the mobile phone of Patent Literature 1 cannot know the data to be transmitted. As a result, a user himself/herself needs to select data to be transmitted to the automatic gate, and so on, which reduces convenience for the user.

The main object of the present invention is to provide an authentication terminal, a system, a control method of an authentication terminal, and a storage medium that contributes to improving convenience of a user.

### Solution to Problem

According to a first aspect of the present invention, there is provided an authentication terminal, including: a first acquisition unit that acquires first biometric information of a user from another apparatus when a distance between own terminal and the user reaches a first distance; a second acquisition unit that acquires second biometric information of the user when the distance between the own terminal and the user reaches a second distance; a control unit that performs control to acquire data for authentication from a terminal possessed by the user, which is necessary to determine whether or not to provide a service to the user; and an authentication processing unit that determines that an authentication processing of the user is successful when a result of a matching processing using the first biometric information and the second biometric information is successful and the data for authentication acquired from the terminal is valid.

According to a second aspect of the present invention, there is provided a system, including: a terminal possessed by a user; and an authentication terminal, wherein the authentication terminal including a first acquisition unit that acquires first biometric information of a user from another apparatus when a distance between own terminal and the user reaches a first distance; a second acquisition unit that acquires second biometric information of the user when the distance between the own terminal and the user reaches a second distance; a control unit that performs control to acquire data for authentication from a terminal possessed by the user, which is necessary to determine whether or not to provide a service to the user; and an authentication processing unit that determines that an authentication processing of the user is successful when a result of a matching processing using the first biometric information and the second biometric information is successful and the data for authentication acquired from the terminal is valid.

According to a third aspect of the present invention, there is provided a control method of an authentication terminal, the control method including: acquiring first biometric information of a user from another apparatus when a distance between own terminal and the user reaches a first distance; acquiring second biometric information of the user when the distance between the own terminal and the user reaches a second distance; performing control to acquire data for authentication from a terminal possessed by the user, which is necessary to determine whether or not to provide a service to the user; and determining that an authentication processing of the user is successful when a result of a matching processing using the first biometric information and the second biometric information is successful and the data for authentication acquired from the terminal is valid.

According to a fourth aspect of the present invention, there is provided a computer-readable storage medium, storing a program causing a computer mounted on an authentication terminal to perform processing for: acquiring first biometric information of a user from another apparatus when a distance between own terminal and the user reaches a first distance; acquiring second biometric information of the user when the distance between the own terminal and the user reaches a second distance; performing control to acquire data for authentication from a terminal possessed by the user, which is necessary to determine whether or not to provide a service to the user; and determining that an authentication processing of the user is successful when a result of a matching processing using the first biometric information and the second biometric information is successful and the data for authentication acquired from the terminal is valid.

### Advantageous Effects of Invention

The individual aspects of the present invention provide an authentication terminal, a system, a control method of an authentication terminal, and a storage medium, which contribute to improving convenience of a user. The advantageous effects of the present invention are not limited to the above advantageous effect. The present invention may provide other advantageous effects, instead of or in addition to the above advantageous effect.

### BRIEF DESCRIPTION OF THE DRAWINGS

FIG. 1 is a diagram illustrating an outline of an example embodiment.

FIG. 2 is a diagram illustrating an example of a schematic configuration of an authentication system according to a first example embodiment.

FIG. 3 is a diagram illustrating a digital wallet of a terminal according to the first example embodiment.

FIG. 4 is a diagram illustrating an operation of the authentication system according to the first example embodiment.

FIG. 5 is a diagram illustrating an example of a processing configuration of the terminal according to the first example embodiment.

FIG. 6 is a diagram illustrating an example of a display of the terminal according to the first example embodiment.

FIG. 7 is a flowchart illustrating an example of an operation of the terminal according to the first example embodiment.

FIG. 8 is a diagram illustrating an example of a processing configuration of an authentication terminal according to the first example embodiment.

FIG. 9 is a diagram illustrating an example of a database of person to be matched according to the first example embodiment.

FIG. 10 is a diagram illustrating an operation of a user identification unit according to the first example embodiment.

FIGS. 11A and 11B illustrate diagrams illustrating an example of a display of the authentication terminal according to the first example embodiment.

FIGS. 12A and 12B are diagrams illustrating an example of a display of the authentication terminal according to the first example embodiment.

FIGS. 13A and 13B are diagrams illustrating an example of a display of the authentication terminal according to the first example embodiment.

FIGS. 14A and 14B are diagrams illustrating an example of a display of the authentication terminal according to the first example embodiment.

FIG. 15 is a flowchart illustrating an example of an operation of the authentication terminal according to the first example embodiment.

FIG. 16 is a sequence diagram illustrating an example of an operation in the authentication system according to the first example embodiment.

FIG. 17 is a diagram illustrating an example of a display of the terminal according to a variation of the first example embodiment.

FIG. 18 is a diagram illustrating an example of a display of the terminal according to the variation of the first example embodiment.

FIG. 19 is a sequence diagram illustrating an example of an operation of the authentication system according to the variation of the first example embodiment.

FIG. 20 is a diagram illustrating an example of a schematic configuration of an authentication system according to a second example embodiment.

FIG. 21 is a diagram illustrating an example of a processing configuration of a terminal according to the second example embodiment.

FIG. 22 is a diagram illustrating an example of a processing configuration of a server apparatus according to the second example embodiment.

FIG. 23 is a diagram illustrating an example of a display of the terminal according to the second example embodiment.

FIG. 24 is a diagram illustrating an example of a user information database according to the second example embodiment.

FIG. 25 is a diagram illustrating an example of a hardware configuration of the authentication terminal for the present application.

### EXAMPLE EMBODIMENT

First, an outline of an example embodiment will be described. In the following outline, various components are denoted by reference characters for the sake of convenience. That is, the following reference characters are used as examples to facilitate the understanding of the present invention. Thus, the description of the outline is not intended to impose any limitations. In addition, unless otherwise specified, an individual block illustrated in the drawings represents a configuration of a functional unit, not a hardware unit. An individual connection line between blocks in the drawings signifies both one-way and two-way directions. An arrow schematically illustrates a principal signal (data) flow and does not exclude bidirectionality. In the present description and drawings, elements that can be described in a like way will be denoted by a like reference character, and redundant description thereof will be omitted as needed.

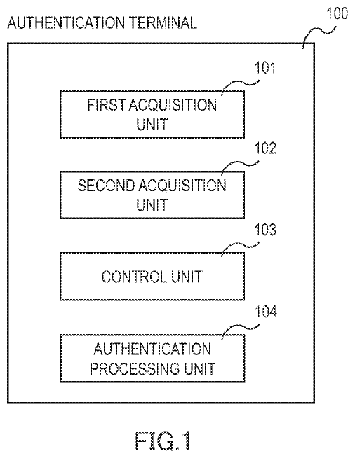

An authentication terminal 100 according to an example embodiment includes a first acquisition unit 101, a second acquisition unit 102, a control unit 103, and an authentication processing unit 104 (see FIG. 1). The first acquisition unit 101 acquires first biometric information of a user from another apparatus when a distance between own terminal and the user reaches a first distance. The second acquisition unit 102 acquires second biometric information of the user when the distance between own terminal and the user reaches a second distance. The control unit 103 performs control to acquire data for authentication from a terminal possessed by the user, which is necessary to determine whether or not to provide a service to the user. The authentication processing unit 104 determines that an authentication processing of the user is successful when a result of the matching processing using the first biometric information and the second biometric information is successful and the data for authentication acquired from the terminal is valid.

The authentication terminal 100 requests the terminal possessed by the user to provide the data for authentication required for authenticating the user. That is, the authentication terminal 100 identifies information for determining whether the user is permitted to pass according to a location and function of own terminal, and requests the terminal to provide the identified information. The terminal selects and transmits a certificate, and so on, requested by the authentication terminal 100 from among various types of certificates, identity documents, and so on, which are stored internally in a form such as a digital wallet. The authentication terminal 100 authenticates the user based on the acquired data for authentication and provides a service. In this way, since the terminal of the user automatically provides information required for authentication processing to the authentication terminal 100, the user who receives a service provided by the authentication terminal 100 does not need to select and present the information required for authentication processing on his or her own. As a result, convenience of the user is improved.

Hereinafter, specific example embodiments will be described in more detail with reference to drawings.

### First Example Embodiment

A first example embodiment will be described in more detail with reference to drawings.

### System Configuration

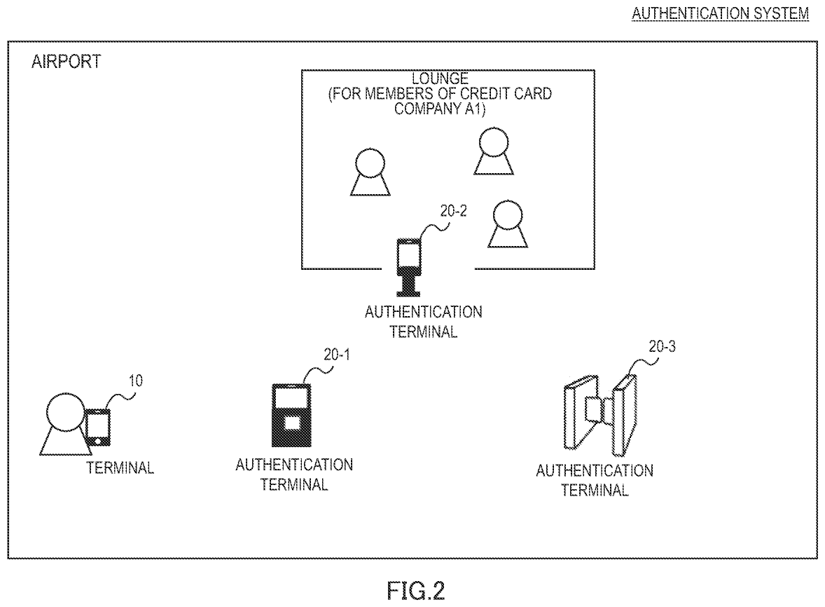

FIG. 2 is a diagram illustrating an example of a schematic configuration of an authentication system (information processing system) according to the first example embodiment. As shown in FIG. 2, the authentication system includes a terminal 10 and a plurality of authentication terminals 20-1 to 20-3.

A user possesses the terminal 10. The terminal 10 is, for example, a mobile terminal such as a smartphone, a tablet, or the like.

Each of the authentication terminals 20-1 to 20-3 is a terminal that provides a predetermined service to a user who has been successfully authenticated. In the first example embodiment, a case will be considered in which the authentication system of the present application is applied to an airport system, as shown in FIG. 2.

In the following description, unless there is a particular reason to distinguish the authentication terminals 20-1 to 20-3 from each other, any one of these authentication terminals 20-1 to 20-3 will simply be referred to as an “authentication terminal 20”. Each authentication terminal 20 is installed at various locations throughout the airport.

For example, the authentication terminal 20-1 is a kiosk terminal for a user to perform a check-in procedure. The authentication terminal 20-2 is a terminal installed at entrance/exit of lounge that can be used by members of airline or credit card company. In an example of FIG. 2, the authentication terminal 20-2 permits members of credit card company A1, to use the lounge. The authentication terminal 20-3 is a gate apparatus installed at a boarding gate. The authentication terminal 20-3 permits a user to pass through the gate when the user has a passport and boarding pass. Alternatively, the authentication terminal 20 may be a gate apparatus (face recognition gate) that controls a passage of a user or a ticket issuing machine that issues tickets.

The terminal 10 and each authentication terminal 20 are configured to be able to communicate by means of short-range wireless communication such as Bluetooth (registered trademark).

The configuration shown in FIG. 2 is an example and is not intended to limit the configuration of the system. For example, the authentication system may include at least one or more of the authentication terminals 20. In addition, although one user (one terminal 10) is illustrated in FIG. 2, it is of course not intended to limit the number of users or terminals 10.

### Outline of Operation

Next, an outline of operations of the authentication system according to the first example embodiment will be described.

### <Preparation of Digital Wallet>

A user installs an application to realize a digital wallet on the terminal 10 that he or she possesses. By creating the digital wallet on the terminal 10, the user stores various types of certificates on the terminal 10, such as electronic money, credit card information, identification document such as a passport or driver's license, vaccination certificate or negative certificate (common pass) regarding infectious disease.

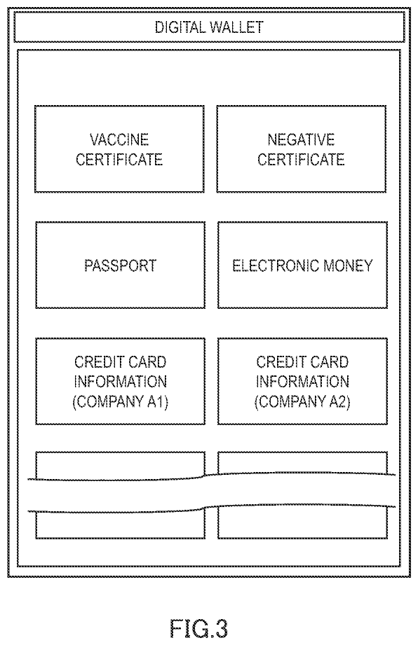

For example, the terminal 10 of the user stores digital information as shown in FIG. 3. In the following descriptions, information (data) stored by the digital wallet of the terminal 10 is described as “electronic wallet data”. The electronic wallet data represents digital data that corresponds to a card, or the like stored in the regular wallet. That is, the electronic wallet data represents digital data regarding a qualification, property, status, condition, attributes, and so on, of the user.

For example, examples of the electronic wallet data include electronic money as means of payment, account information for crypto-assets, credit card information, official identification documents such as driver's licenses, and health-related certificates such as a vaccination certificate. Alternatively, examples of the electronic wallet data include digital data such as a medical examination card from the hospital, and so on, membership card from the retail store, and so on, a point card, coupon, employee ID card, student ID card, and so on.

The terminal 10 stores a user ID and biometric information of the user in addition to the electronic wallet data. For example, the user operates the terminal 10 and photographs his or her own face. The terminal 10 stores the face image or a feature value generated from the face image as biometric information of the user.

For example, the biometric information of a user is data (feature values) calculated from physical features unique to this individual user. The physical features are about the face, a fingerprint, a voiceprint, a vein, a retina, or an iris pattern of an eye of the user. Alternatively, the biometric information of a user may be image data of a face image or a fingerprint image of the user, for example. The biometric information of a user may be any information including physical features of the user. The present application describes a case in which biometric information (a face image or a feature value generated from the face image) regarding a “face” of a person is used.

### <Providing Service>

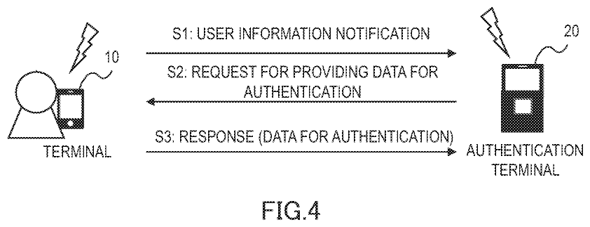

A user who possesses the terminal 10 on which a digital wallet is configured approaches the authentication terminal 20 while holding the terminal 10 (see FIG. 4). When a distance between the terminal and the authentication terminal 20 reaches a predetermined distance (a distance that can be communicated by short-range wireless communication; for example, a distance of several meters), the terminal 10 transmits a “user information notification” to the authentication terminal 20 (step S1).

For example, the terminal 10 transmits the user information notification that includes biometric information of a user and a user ID of the user to the authentication terminal 20. The authentication terminal 20 stores the user ID and the biometric information included in the notification in a database of person to be matched. Note that details of the database of person to be matched will be described below.

After that, the user in possession of the terminal 10 arrives at the authentication terminal 20. When the user has arrived, the authentication terminal 20 acquires biometric information of the user. For example, the authentication terminal 20 acquires a face image by photographing the user.

The authentication terminal 20 performs a matching processing (1-to-N matching; N is a positive integer, the same applies to the following description) using the biometric information acquired from the terminal 10 (biometric information included in the user information) and the biometric information acquired by photographing. If the matching processing is successful, the authentication terminal 20 determines that the user who possesses the terminal 10 is legitimate. In other words, if the biometric information (face image, feature value) that the user has registered in advance in the terminal 10 and the biometric information acquired from the user who has appeared before in front of the authentication terminal 20 substantially match, the authentication terminal 20 can determine that the legitimate holder or owner of the terminal 10 has appeared in front of own terminal.

If the matching processing is successful, the authentication terminal 20 requests the terminal 10 to provide data required to determine whether or not to provide a service to the user who has successfully completed the matching processing. That is, the authentication terminal 20 requests the terminal 10 to provide data for authentication of the user who has arrived at own terminal. In the following descriptions, the data that the authentication terminal 20 requests the terminal 10 to provide will be described as “data for authentication”. The authentication terminal 20 transmits a request for providing data for authentication including a detail of the data for authentication that the authentication terminal 20 requires the terminal 10 to provide (step S2).

For example, the authentication terminal 20 specifies a type of data for authentication and instructs the terminal 10 to transmit the specified data for authentication. The data for authentication (type of data for authentication) specified by the authentication terminal 20 differs depending on a location where the authentication terminal 20 is installed, a function that has been set, and so on. For example, consider a case when a user performing a check-in procedure is required to present a vaccination certificate. In this case, the authentication terminal 20-1 shown in FIG. 2 requests the terminal 10 to provide the vaccination certificate. That is, the “data for authentication” that the authentication terminal 20-1 requests the terminal 10 to provide is the “vaccination certificate”.

Alternatively, as shown in FIG. 2, when the authentication terminal 20-2 is located in a lounge exclusively for members of credit card company A1, the authentication terminal 20-2 requests the terminal 10 to provide information on credit card of the credit card company A1. In this case, the “data for authentication” that the authentication terminal 20-2 requests the terminal 10 is the “credit card information of credit card company A1”.

If the terminal 10 stores requested information, the terminal 10 transmits the requested information (data for authentication) to the authentication terminal 20. More specifically, if an electronic wallet data includes the data for authentication requested by the authentication terminal 20, the terminal 10 transmits the corresponding electronic wallet data to the authentication terminal 20. The terminal 10 transmits a positive response that includes the data for authentication specified by the authentication terminal 20 to the authentication terminal 20 (step S3).

If the terminal 10 does not store the requested data for authentication, the terminal 10 transmits a negative response to the authentication terminal 20 indicating that the terminal does not store the requested data for authentication.

The authentication terminal 20 performs authentication of the user based on the acquired data for authentication. The authentication terminal 20 provides a service to the user who has been successfully authenticated. In this way, the authentication terminal 20 decides whether or not to provide a service to a user based on the data for authentication.

For example, the authentication terminal 20-1 shown in FIG. 2 determines that the authentication of the user is successful when the user possesses a valid vaccination certificate (vaccination certificate whose validity period has not expired). The authentication terminal 20-1 provides a service related to a check-in procedure to the person who has been successfully authenticated (the authenticated person who has been determined to be successfully authenticated).

When the validity period of the vaccination certificate has expired or the terminal 10 does not store the vaccination certificate, the authentication terminal 20-1 determines that the authentication of the user has failed. In this case, the authentication terminal 20-1 notifies the user that it is not possible to continue the check-in procedure at own terminal. At that time, the authentication terminal 20-1 may guide the user to go to a counter where airline company staff members are waiting.

Alternatively, when the user is a member of the credit card company A1 (in possession of valid credit card from the credit card company A1), the authentication terminal 20-2 determines that the user has been successfully authenticated. The authentication terminal 20-2 guides the person who has been successfully authenticated (the authenticated person who has been determined to be successfully authenticated) to enter the lounge. On the other hand, for the user who does not have the valid credit card of the credit card company A1, the authentication terminal 20-2 determines that the authentication has failed. In this case, the authentication terminal 20-2 notifies the user that the lounge cannot be used.

Next, details of the individual apparatuses included in the authentication system according to the first example embodiment will be described.

### Terminal

Examples of the terminal 10 include a mobile terminal apparatus such as a smartphone, a mobile phone, a game console, a tablet, or the like. The terminal 10 can be any equipment or device that accepts an operation by a user and can communicate with the authentication terminal 20.

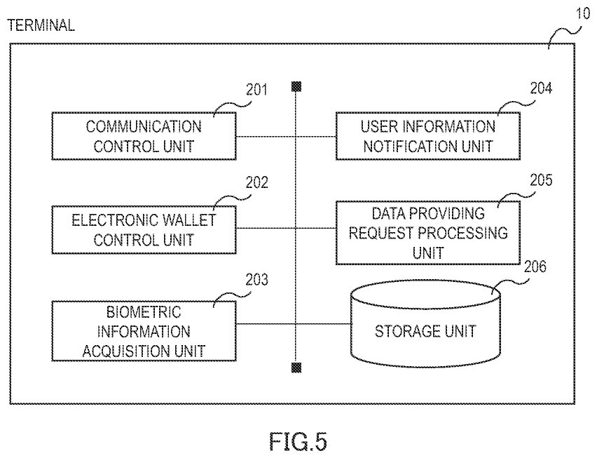

FIG. 5 is a diagram illustrating an example of a processing configuration (processing modules) of the terminal 10 according to the first example embodiment. Referring to FIG. 5, terminal 10 includes a communication control unit 201, an electronic wallet control unit 202, a biometric information acquisition unit 203, a user information notification unit 204, a data providing request processing unit 205, and a storage unit 206.

The communication control unit 201 is means for controlling communication with other apparatuses. For example, the communication control unit 201 receives data (packets) from the authentication terminal 20. In addition, the communication control unit 201 transmits data to the authentication terminal 20. The communication control unit 201 gives data received from other apparatuses to other processing modules. The communication control unit 201 transmits data acquired from other processing modules to other apparatuses. In this way, other processing modules transmit and receive data to and from other apparatuses via the communication control unit 201. The communication control unit 201 includes a function as a receiving unit that receives data from other apparatuses and a function as a transmitting unit that transmits data toward other apparatuses.

The communication control unit 201 is compatible with short-range wireless communication such as Bluetooth (registered trademark) and communicates with the authentication terminal 20 through the short-range wireless communication. When the communication control unit 201 completes a connection with the authentication terminal 20, the communication control unit 201 notifies the user information notification unit 204 to that effect. Note that it is assumed that a pairing process required when the terminal 10 and the authentication terminal 20 communicate via the Bluetooth (registered trademark) has been completed in advance.

The electronic wallet control unit 202 is means for managing, controlling, and so on regarding a digital wallet. The electronic wallet control unit 202 acquires various types of electronic wallet data in response to an operation by a user and stores the data in the storage unit 206.

Note that the electronic wallet control unit 202 is realized by an application installed in the terminal 10. Detailed descriptions regarding the installation of the application to realize the digital wallet and registration of specific electronic wallet data will be omitted. This is because these operations and the like are different from the purpose of the present application.

For example, with respect to the registration of the electronic wallet data, a user may operate the terminal 10 to access a home page provided by issuer of various types of information, and register the electronic wallet data in the digital wallet from the home page.

For example, with respect to vaccination certificate or negative certificate, the electronic wallet control unit 202 accesses a home page or the like managed by the certificate issuing entity, such as a local government or medical institution. The electronic wallet control unit 202 acquires the vaccination certificate or the negative certificate by inputting an ID of the user, and so on, into the home page in response to operation by the user, and stores the vaccination certificate or the negative certificate in the storage unit 206. Alternatively, the electronic wallet control unit 202 may acquire the vaccination certificate, and so on, by photographing two-dimensional code described on the vaccination certificate, and so on, in response to operation by the user. In this way, the electronic wallet control unit 202 may acquire the vaccination certificate, and so on, by accessing the local government or medical institution, or the user may register the vaccination certificate, and so on, in the digital wallet by himself/herself.

Alternatively, with respect an identification document such as a passport or driver's license, the electronic wallet control unit 202 may capture images of these certificates in response to operation by the user and store the image data as electronic wallet data related to the passport, driver's license, and so on.

Furthermore, the electronic wallet control unit 202 generates a user ID to identify the user who owns the digital wallet. The user ID may be any information as long as it can uniquely identify the user. For example, the electronic wallet control unit 202 may acquire an email address from the user and handle the email address as the user ID. The electronic wallet control unit 202 stores the user ID in the storage unit 206.

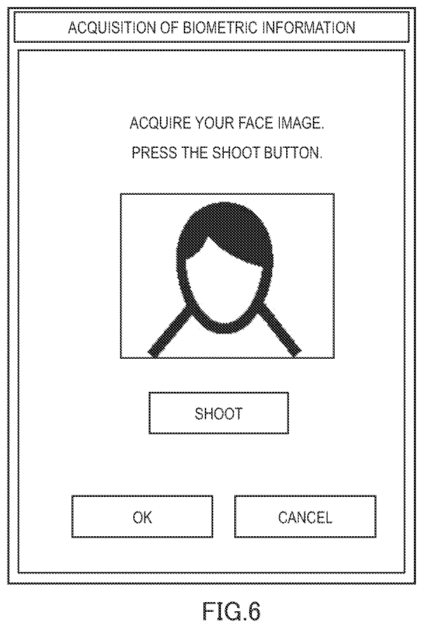

The biometric information acquisition unit 203 is means for acquiring biometric information of a user. For example, the biometric information acquisition unit 203 acquires biometric information (face image) using a GUI (Graphical User Interface) as shown in FIG. 6. The biometric information acquisition unit 203 generates a feature value from the acquired face image and stores the generated feature value in the storage unit 206.

An existing technique can be used to generation process of the feature value, and therefore, detailed description thereof will be omitted. For example, the biometric information acquisition unit 203 extracts the eyes, nose, mouth, etc. as feature points from the face image. Next, the biometric information acquisition unit 203 calculates, as feature values, the location of the individual feature point and the distance between feature points and generates a feature vector formed by a plurality of feature values (vector information that features the face image).

The user information notification unit 204 is means for notifying the authentication terminal 20 of user information. When the terminal 10 and the authentication terminal 20 start communication, the user information notification unit 204 reads out biometric information (feature value generated from face image) and the user ID stored in the storage unit 206. The user information notification unit 204 transmits a “user information notification” that includes the read biometric information and the user ID to the authentication terminal 20.

In this way, when the user information notification unit 204 starts communication with the authentication terminal 20 by short-range wireless communication means, the user information notification unit 204 transmits biometric information (first biometric information; for example, a feature value) to the authentication terminal 20.

The data providing request processing unit 205 is means for processing a request for providing data for authentication received from the authentication terminal 20. When the data providing request processing unit 205 receives a “request for providing data for authentication” from the authentication terminal 20, the data providing request processing unit 205 determines whether or not a user ID included in the request for providing data for authentication matches the user ID stored in the storage unit 206.

If the two user IDs do not match, the data providing request processing unit 205 determines that the request for providing data for authentication is not a request for providing data for authentication transmitted to own terminal and does not perform any special processing. The data providing request processing unit 205 may discard the received request for providing data for authentication.

If the two user IDs match, the data providing request processing unit 205 attempts to read out electronic wallet data corresponding to a type of data for authentication included in the request from the storage unit 206 from the storage unit 206.

If electronic wallet data corresponding to the data for authentication specified by the authentication terminal 20 exists, the data providing request processing unit 205 transmits a positive response that includes the read electronic wallet data to the authentication terminal 20. If electronic wallet data corresponding to the data for authentication specified by the authentication terminal 20 do not exist, the data providing request processing unit 205 transmits a negative response indicating that fact to the authentication terminal 20.

The storage unit 206 is means for storing information necessary for an operation of the terminal 10.

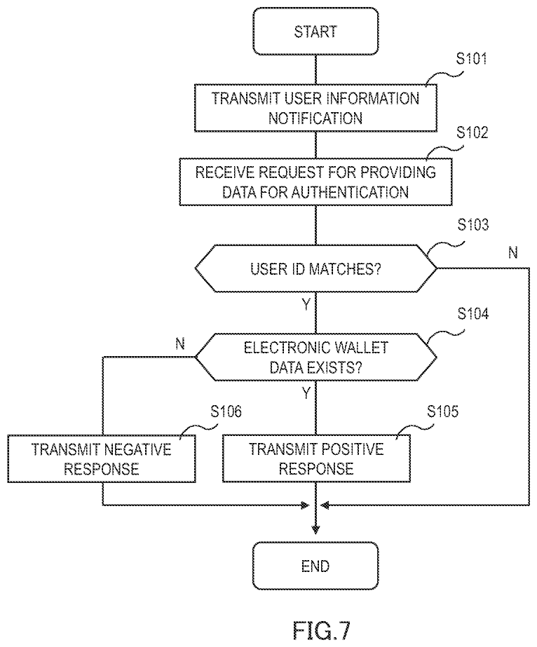

The operation of the terminal 10 is summarized in a flowchart shown in FIG. 7. FIG. 7 is the flowchart illustrating an example of an example embodiment of the operation of the terminal 10 according to the first example embodiment. Note that a description of an operation related to creating a digital wallet will be omitted.

First, the terminal 10 detects a communication connection with the authentication terminal 20 and transmits a user information notification that includes a user ID and biometric information to the authentication terminal 20 (step S101).

The terminal 10 receives a request for providing data for authentication (step S102).

The terminal 10 determines whether or not the user ID included in the request for providing data for authentication matches the stored user ID within own terminal (step S103).

If the two user IDs do not match (step S103, No branch), the terminal 10 terminates the process.

If the two user IDs match (step S103, Yes branch), the terminal 10 determines whether or not electronic wallet data corresponding to the data for authentication specified by the request for providing data for authentication exists (step S104).

If the corresponding electronic wallet data exists (step S104, Yes branch), the terminal 10 transmits a positive response that includes the corresponding electronic wallet data (data for authentication specified by the authentication terminal 20) to the authentication terminal 20 (step S105).

If the corresponding electronic wallet data does not exist (step S104, No branch), the terminal 10 transmits a negative response to the authentication terminal 20 indicating that the specified data for authentication does not exist (step S106).

### Authentication Terminal

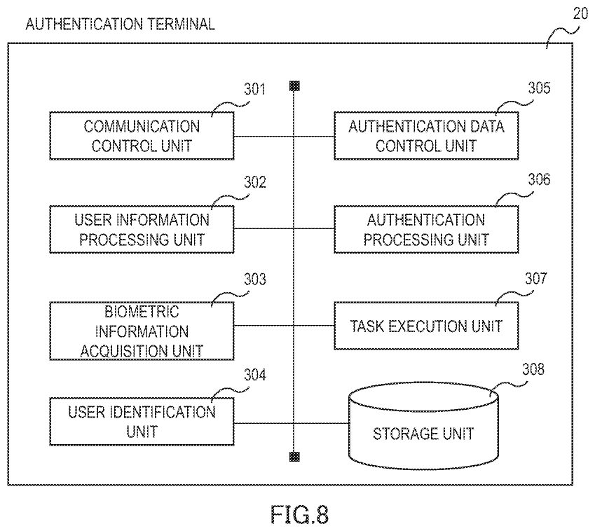

FIG. 8 is a diagram illustrating an example of a processing configuration (processing modules) of the authentication terminal 20 according to the first example embodiment. Referring to FIG. 8, the authentication terminal 20 includes a communication control unit 301, a user information processing unit 302, a biometric information acquisition unit 303, a user identification unit 304, an authentication data control unit 305, an authentication processing unit 306, a task execution unit 307, and a storage unit 308.

The communication control unit 301 is means for controlling communication with other apparatuses. For example, the communication control unit 301 receives data (packets) from the terminal 10. In addition, the communication control unit 301 transmits data to the terminal 10. The communication control unit 301 gives data received from other apparatuses to other processing modules. The communication control unit 301 transmits data acquired from other processing modules to other apparatuses. In this way, other processing modules transmit and receive data to and from other apparatuses via the communication control unit 301. The communication control unit 301 includes a function as a receiving unit that receives data from other apparatuses and a function as a transmitting unit that transmits data to other apparatuses.

The communication control unit 301 is compatible with short-range wireless communication such as Bluetooth (registered trademark) and communicates with the terminal 10 through the short-range wireless communication.

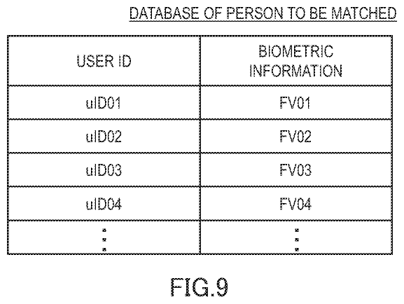

The user information processing unit 302 is means (first acquisition unit) for acquiring biometric information of a user (first biometric information) from another apparatus when a distance between own terminal and the user reaches a first distance (for example, Bluetooth (registered trademark) communication distance). Specifically, the user information processing unit 302 performs processing related to a user information notification received from the terminal 10. When the user information processing unit 302 acquires the user information notification, the user information processing unit 302 registers the user ID and biometric information (feature value) included in the notification in the database of person to be matched (see FIG. 9).

As shown in FIG. 9, the database of person to be matched includes a user ID field and a biometric information field. Note that the database of person to be matched shown in FIG. 9 is an example and is not intended to limit the items to be stored. For example, the date and time of registration of an entry may be stored in the database.

The biometric information acquisition unit 303 is means for controlling a camera device (camera device included in the authentication terminal 20) and acquiring biometric information of a user (for example, face image) who has arrived at the authentication terminal 20 (user who has arrived at a predetermined area in front of the authentication terminal 20). The biometric information acquisition unit 303 is a second acquisition unit that acquires biometric information of the user (second biometric information) when the distance between own terminal and the user reaches a second distance (shorter distance than the first distance; distance between the user who has arrived at the authentication terminal 20 and the authentication terminal 20).

The biometric information acquisition unit 303 takes an image of the front of own terminal periodically or at predetermined timing. The biometric information acquisition unit 303 determines whether the acquired image includes a human face image, and if the human face image is included, extracts the face image from the acquired image data.

An existing technique can be used for the face image detection and extraction processing performed by the biometric information acquisition unit 303, and therefore, detailed description thereof will be omitted. For example, the biometric information acquisition unit 303 may extract a face image (a face area) from the image data by using a learning model learned by a CNN (Convolutional Neural Network). Alternatively, the biometric information acquisition unit 303 may extract a face image by using a technique such as template matching.

The biometric information acquisition unit 303 generates a feature value from the extracted face image. The biometric information acquisition unit 303 hands over the generated feature value (biometric information) to the user identification unit 304.

The user identification unit 304 is means for identifying a user who has reached own terminal (the authentication terminal 20). As described above, when the terminal 10 and the authentication terminal 20 are enabled to communicate (when the terminal 10 and the authentication terminal 20 are connected by short-range wireless communication means), a “user information notification” is transmitted from the terminal 10 to the authentication terminal 20. Specifically, when the terminal 10 and the authentication terminal 20 communicate through Bluetooth (registered trademark), the terminal 10 and the authentication terminal 20 start communicating when a distance between the terminal 10 and the authentication terminal 20 reaches several meters.

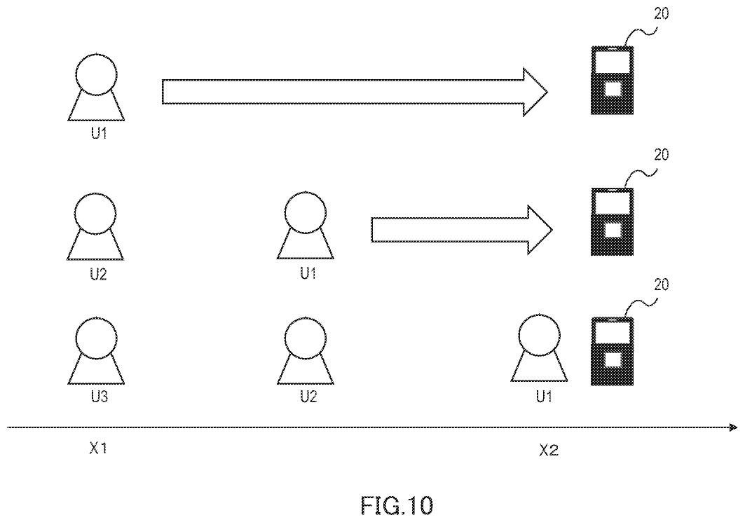

Therefore, it is assumed that user information is transmitted to the authentication terminal 20 from the terminal 10 of another user before the owner (user) of the terminal 10 that transmitted the user information reaches the authentication terminal 20. For example, as shown in FIG. 10, when user U1 arrives at location X1, a user information notification is transmitted to the authentication terminal 20. Note that the illustration of the terminal 10 is omitted in FIG. 10. There is a possibility that user information notifications for user U2 and user U3 may be transmitted to the authentication terminal 20 before user U1 arrives at location X2.

Here, since each user has different walking speed, it is not always the case that users arrive at the authentication terminal 20 in the order in which the user information notifications are transmitted. Therefore, the user identification unit 304 identifies a user who has arrived at the authentication terminal 20 from among at least one or more users (persons to be matched; users who have transmitted user information notification from the terminal 10).

Specifically, when the user identification unit 304 acquires biometric information from the biometric information acquisition unit 303, the user identification unit 304 performs a matching processing using the biometric information and biometric information stored in the database of person to be matched.

The user identification unit 304 calculates a similarity between a feature value of the user who has arrived at own terminal and feature values registered in the database of person to be matched. For the individual similarity, the chi-squared distance, the Euclidean distance, or the like may be used. A longer distance represents a lower similarity, and a shorter distance represents a higher similarity.

If there is a similarity of more than a predetermined value, the user identification unit 304 determines that matching processing has succeeded. If there is no similarity greater than the predetermined value, the user identification unit 304 determines that the matching processing has failed.

The user identification unit 304 notifies the authentication data control unit 305 of a result of the matching processing (matching processing has succeeded or matching processing has failed). When the matching processing has succeeded, the user identification unit 304 notifies the authentication data control unit 305 of a user ID of the entry with the highest degree of similarity (entry in the database of person to be matched).

Note that the matching processing by the user identification unit 304 (matching processing using first and second biometric information) verifies (checks) a legitimacy of the user who has arrived at the authentication terminal 20. For example, even if a third party other than the owner of the terminal 10 arrives at the authentication terminal 20 with the terminal 10, biometric information stored in the terminal 10 and biometric information acquired by the authentication terminal 20 will not match, and thus the matching processing fails.

The authentication data control unit 305 is means for performing control related to acquiring data for authentication. The authentication data control unit 305 performs control related to acquiring data for authentication which is necessary to determine whether or not to provide a service to the user (authenticated person) from the terminal 10 possessed by the user.

Specifically, when the authentication data control unit 305 receives a notification that “matching processing has succeeded” from the user identification unit 304, the authentication data control unit 305 transmits a request for providing data for authentication to the terminal. The request for providing data for authentication includes the user ID acquired from the above user identification unit 304 and details of data for authentication (type of data for authentication) that is requested to be provided.

The authentication data control unit 305 receives a response to the request for providing data for authentication (positive response or negative response) from the terminal 10. The authentication data control unit 305 hands over the response received from the terminal 10 to the authentication processing unit 306.

Note that when the authentication data control unit 305 receives a notification that “matching processing has failed” from the user identification unit 304, the authentication data control unit 305 does not perform any special processing, and notifies the authentication processing unit 306 that the matching processing has failed.

In this way, if the user identification unit 304 succeeds in matching processing, the authentication data control unit 305 specifies data for authentication and requests the terminal 10 to provide the specified data for authentication.

The authentication processing unit 306 is means for performing authentication processing of a user who has arrived at the authentication terminal 20. The authentication processing unit 306 determines that the authentication processing of a user is successful when a result of the matching processing of the user identification unit 304 is successful and the data for authentication acquired from the terminal 10 is valid.

The authentication processing unit 306 performs an authentication of the user based on the data for authentication acquired from the terminal 10. More specifically, the authentication processing unit 306 determines whether or not it is possible to provide a service to the user based on data for authentication. The authentication processing unit 306 performs an authentication processing of the user based on a result of matching processing by the user identification unit 304 and the data for authentication acquired from the terminal 10.

Specifically, when the user identification unit 304 fails in matching process, the authentication processing unit 306 sets “authentication failure” as the result of the authentication of an authenticated person (user who has arrived at the authentication terminal 20).

When the authentication processing unit 306 receives a negative response (notification that the terminal 10 does not store specified data for authentication) from the authentication data control unit 305, the authentication processing unit 306 sets “authentication failure” as the result of authentication of the authenticated person (user who has arrived at the authentication terminal 20).

When the authentication processing unit 306 receives a positive response (response that includes data for authentication) from the authentication data control unit 305, the authentication processing unit 306 determines a validity of the data for authentication included in the positive response. The authentication processing unit 306 sets “authentication success” as the result of authentication of the authenticated person if the data for authentication is valid. The authentication processing unit 306 sets “authentication failure” as the result of authentication of the authenticated person if the data for authentication is invalid.

Note that the determination of validity differs depending on a function assigned to each authentication terminals 20 and so on. For example, the authentication processing unit 306 of the authentication terminal 20-1 shown in FIG. 2 checks the validity period of vaccination certificate acquired from the terminal 10, and determines that “data for authentication is valid” if the period has not expired, and “data for authentication is invalid” if the period has expired. Alternatively, the authentication processing unit 306 may determine the validity of the data for authentication based on whether or not a type of vaccine, or the like, described in the acquired vaccination certificate matches the type of vaccine predetermined for the authentication terminal 20.

Alternatively, the authentication processing unit 306 of the authentication terminal 20-2 checks the validity period of credit card information acquired from the terminal 10 and determines that “data for authentication is valid” if the period has not expired, and “data for authentication is invalid” if the period has expired.

The authentication processing unit 306 notifies the task execution unit 307 of the result of authentication (authentication failure or authentication success). When the authentication is successful, the authentication processing unit 306 hands over the data for authentication to the task execution unit 307 as necessary.

The task execution unit 307 is means for executing a task (operation, processing) assigned to the authentication terminal 20.

For example, the task execution unit 307 of the authentication terminal 20-1 shown in FIG. 2 provides a service related to a check-in procedure to a user. Alternatively, the task execution unit 307 of the authentication terminal 20-2 manages admission to a lounge.

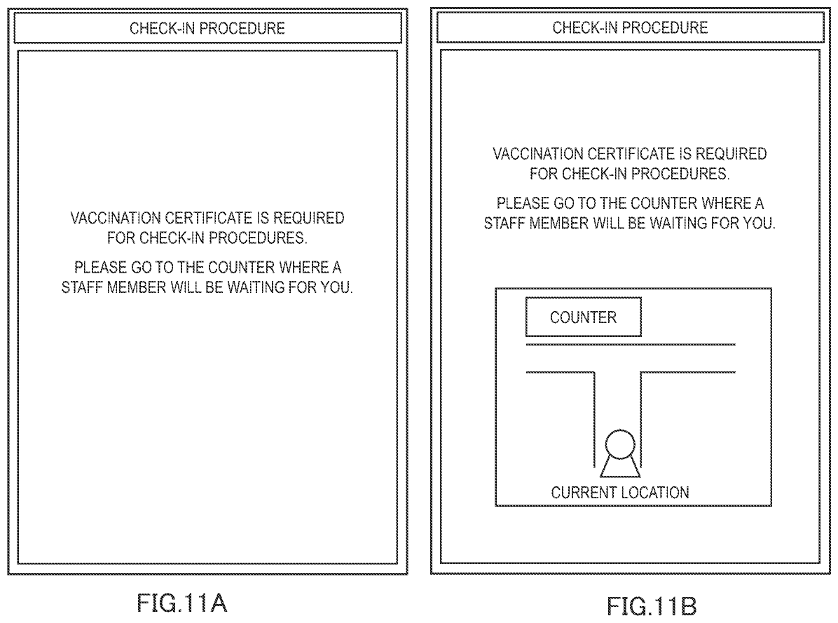

The task execution unit 307 outputs messages according to the result of authentication processing. For example, when the authentication has failed, the task execution unit 307 of the authentication terminal 20-1 provides a display as shown in FIG. 11A. Alternatively, when an authentication has failed, the task execution unit 307 of the authentication terminal 20-1 may provide a display as shown in FIG. 11B and help a user whose behavior has failed in authentication (display of map information that includes reception counter).

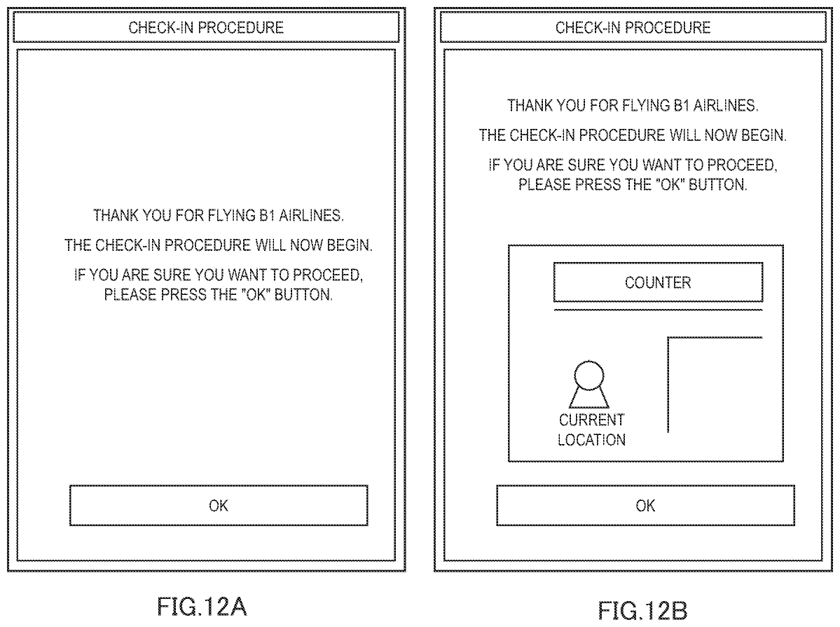

When the authentication has succeeded, the task execution unit 307 of the authentication terminal 20-1 displays a message as shown in FIG. 12A and continues the check-in procedure. Alternatively, when an authentication has succeeded, the task execution unit 307 of the authentication terminal 20-1 may display map information as shown in FIG. 12B, and clearly indicate location where the check-in procedure is being performed. In this way, when the task execution unit 307 executes the check-in procedure that requires vaccination certificate, the task execution unit 307 outputs messages as shown in FIGS. 11A, 11B, 12A and 12B, according to the result of authentication.

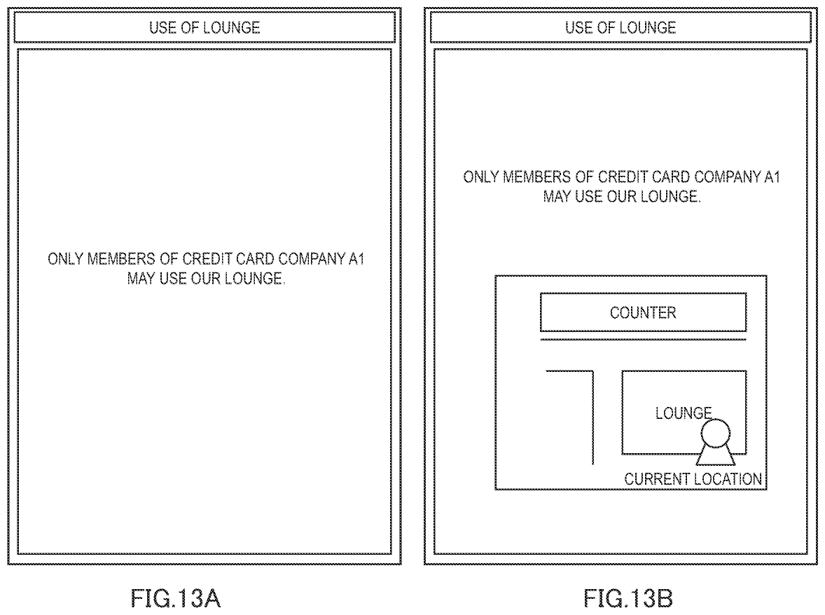

When an authentication has failed, the task execution unit 307 of the authentication terminal 20-2 displays a message as shown in FIG. 13A, and notifies a user that only member of credit card company is allowed to use the lounge. Alternatively, when the authentication has failed, the task execution unit 307 of the authentication terminal 20-2 may provide a display as shown in FIG. 13B, and display map information that clearly indicates a location of the lounge (current location of user).

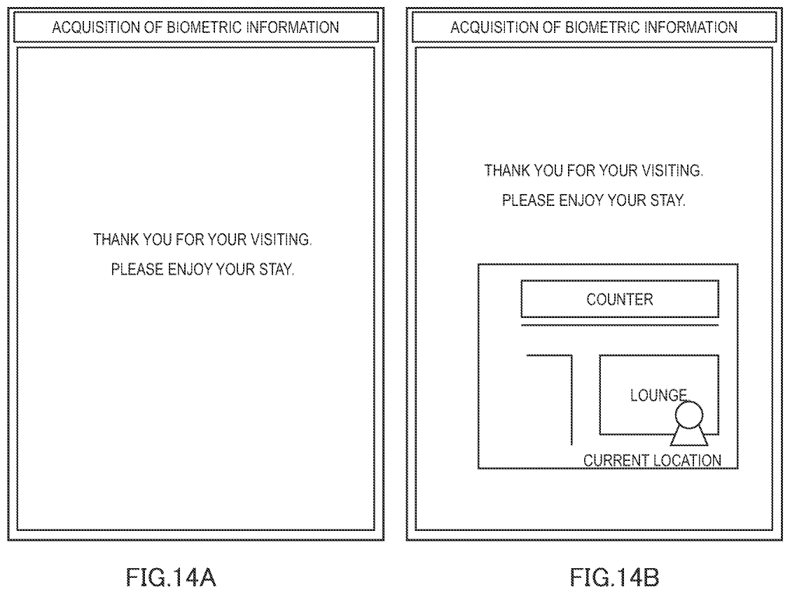

Alternatively, when the authentication has succeeded, the task execution unit 307 of the authentication terminal 20-2 may provide a display as shown in FIG. 14A, and welcome use of the lounge by a user. Alternatively, even if the authentication has succeeded, the task execution unit 307 of the authentication terminal 20-2 may provide a display as shown in FIG. 14B and display map information that clearly indicates a location of the lounge (current location of user). In this way, the task execution unit 307 outputs messages as shown in FIGS. 13A, 13B, 14A and 14B according to the result of authentication, when the task execution unit 307 executes procedures for entering the lounge where credit card information is required.

Note that when the task execution unit 307 has failed in authentication because a matching processing using the biometric authentication had failed, the task execution unit 307 may re-acquire the biometric information of a user or attempt matching using other biometric information. When using other biometric information (for example, iris information, a fingerprint, or a palmprint), these biometric information are stored in the terminal 10 in advance. By taking these actions, it is possible to appropriately handle cases, such as when a clear face image cannot be acquired due to an environment in which the authentication terminal 20 is set up, and so on.

The storage unit 308 is means for storing information necessary for an operation of the authentication terminal 20. The database of person to be matched is established in the storage unit 308.

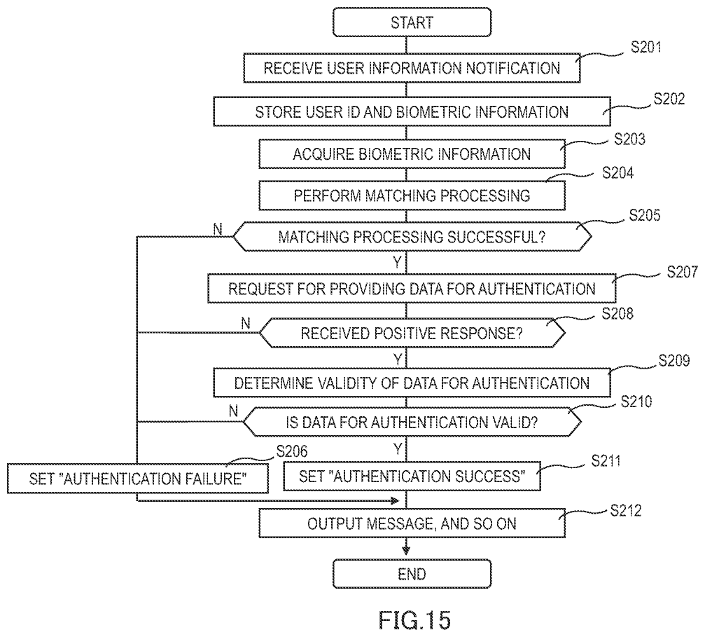

The operation of the authentication terminal 20 are summarized in a flowchart shown in FIG. 15. FIG. 15 is the flowchart illustrating an example of the operation of the authentication terminal 20 according to the first example embodiment.

The authentication terminal 20 receives a user information notification from the terminal 10 (step S201).

The authentication terminal 20 stores user ID and biometric information included in the user information notification in the database of person to be matched (step S202).

The authentication terminal 20 acquires biometric information of a user when the user arrives at own terminal (step S203).

The authentication terminal 20 performs matching processing using the acquired biometric information and the biometric information stored in the database of person to be matched (step S204).

If the matching processing has failed (step S205, No branch), the authentication terminal 20 sets “authentication failure” as a result of authentication of the user (step S206).

If the matching processing has succeeded (step S205, Yes branch), the authentication terminal 20 transmits a request for providing data for authentication to the terminal 10 (step S207).

The authentication terminal 20 receives a response from the terminal 10 to the request for providing data for authentication and checks the contents of the response. When a negative response is received (step S208, No branch), the authentication terminal 20 sets “authentication failure” as the result of authentication of the user (step S206).

When a positive response is received (step S208, Yes branch), the authentication terminal 20 determines validity of the acquired data for authentication (step S209).

When the data for authentication is invalid (step S210, No branch), the authentication terminal 20 sets “authentication failure” as the result of authentication of the user (step S206).

When the data for authentication is valid (step S210, Yes branch), the authentication terminal 20 sets “authentication success” as the result of authentication of the user (step S211).

The authentication terminal 20 executes task assigned in advance (step S212) while outputting messages or the like according to the result of authentication.

### System Operation

Next, operations in the authentication system according to the first example embodiment will be described.

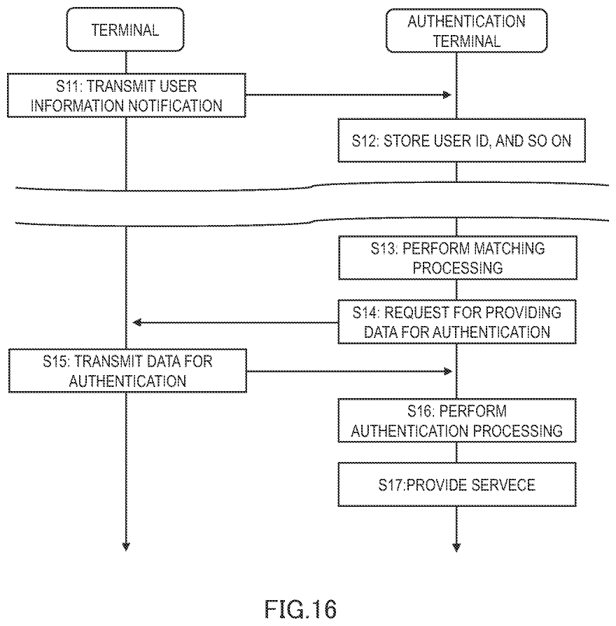

FIG. 16 is a sequence diagram illustrating an example of an operation in the authentication system according to the first example embodiment. Referring to FIG. 16, the operation of the authentication system according to the first example embodiment will be described.

When the terminal 10 and the authentication terminal 20 reach a predetermined distance, the terminal 10 transmits a user information notification that includes user ID and biometric information to the authentication terminal 20 (step S11).

The authentication terminal 20 stores the acquired user ID and biometric information in the database of person to be matched (step S12).

When a user arrives at the authentication terminal 20, the authentication terminal 20 acquires biometric information of the user and performs matching processing (step S13).

When the matching process has succeeded, the authentication terminal 20 transmits a request for providing data for authentication that includes the user ID of identified by the matching processing and a detail of the data for authentication to the terminal 10 (step S14).

The terminal 10 transmits the data for authentication (electronic wallet data) specified by the authentication terminal 20 to the authentication terminal 20 (step S15).

The authentication terminal 20 performs authentication processing using the acquired data for authentication (step S16).

When the authentication processing has succeeded (when the data for authentication is valid), the authentication terminal 20 provides a service to a person who has been successfully authenticated (the authenticated person who has been determined to be authenticated successfully) (step S17).

### <Variation 1 According to the First Example Embodiment>

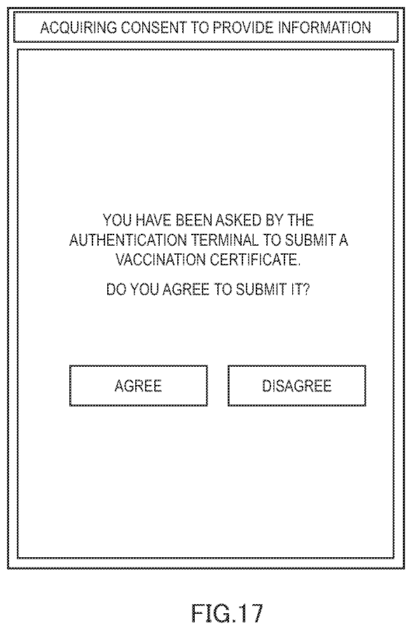

When the terminal 10 of a user receives a request for providing data for authentication from the authentication terminal 20, the terminal 10 may inquire the user whether it is acceptable to provide the authentication data (electronic wallet data) specified by the authentication terminal 20. Specifically, when the data providing request processing unit 205 of the terminal 10 receives the request for providing data for authentication and the specified electronic wallet data is stored in the storage unit 206, the data providing request processing unit 205 may check intention of the user by GUI as shown in FIG. 17.

When the user agrees to provide the data, the data providing request processing unit 205 transmits a positive response that includes the electronic wallet data specified by the authentication terminal 20 to the authentication terminal 20. When the user refuses to provide the data, the data providing request processing unit 205 transmits a negative response to the request for providing data for authentication to the authentication terminal 20.

In this way, when the terminal 10 is requested by the authentication terminal 20 to specify data for authentication and provide the specified data for authentication, the terminal 10 may acquire consent from the user to provide the specified data for authentication to the authentication terminal 20.

### <Variation 2 According to the First Example Embodiment>

In the above example embodiment, it is assumed that the Bluetooth (registered trademark) of the terminal 10 is turned on. However, it is also possible that the Bluetooth (registered trademark) function of the terminal 10 is turned off.

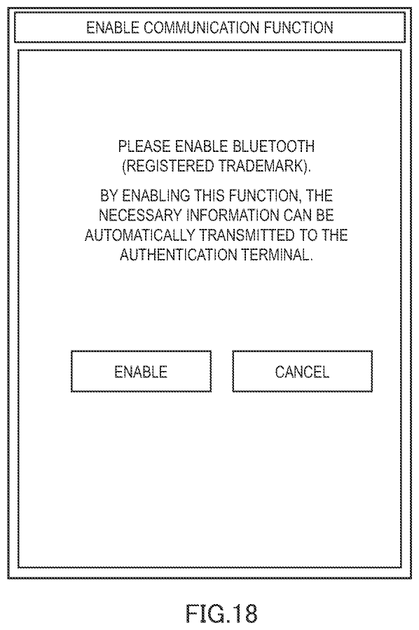

In this case, the terminal 10 may guide the user to turn on the Bluetooth (registered trademark) function when own terminal approaches the authentication terminal 20. For example, the user information notification unit 204 of the terminal 10 may display a GUI as shown in FIG. 18 to prompt the user to enable the Bluetooth (registered trademark) function.

Note that the terminal 10 (user information notification unit 204) acquires a location where the authentication terminal 20 is installed (location information; X coordinate, Y coordinate) from an external server on the Internet. Furthermore, the user information notification unit 204 receives a GPS signal from the GPS (Global Positioning System) satellite, executes positioning, and generates location information that includes the latitude and longitude of own terminal. Alternatively, the user information notification unit 204 may communicate with a wireless access point and treat the location of the wireless access point as the location of own terminal. Alternatively, the user information notification unit 204 may generate the location information based on strength of a radio wave received from the wireless access point.

The user information notification unit 204 determines whether or not own terminal is close to the authentication terminal 20 using the location information of the authentication terminal 20 acquired from the external server and the location information of own terminal generated above. Specifically, the user information notification unit 204 determines that there is the authentication terminal 20 nearby if the authentication terminal 20 is installed within a predetermined range centered on own terminal.

In this way, the terminal 10 may prompt the user to enable the short-range wireless communication means when a distance between the terminal 10 and the authentication terminal 20 reaches a third distance.

Note that a trigger for prompting the user to turn on Bluetooth (registered trademark) may be other than the terminal 10 approaching the authentication terminal 20. For example, the user may be prompted to turn on the Bluetooth (registered trademark) based on a date and time. For example, when the user has booked a flight ticket, the terminal 10 estimates the date and time when the user will arrive at a departure airport based on booking information of the flight ticket. The terminal 10 may prompt the user to turn on the Bluetooth (registered trademark) based on the estimated date and time. For example, the terminal 10 may prompt the user to turn on the Bluetooth (registered trademark) several hours before a departure time. For example, when the user has booked an aircraft departing at 14:00, the terminal 10 may prompt the user to turn on the Bluetooth (registered trademark) at 12:00.

In addition, the terminal 10 may display a list of data for authentication requested by each authentication terminal 20 (list of a certificate, and so on, that needs to be provided to each authentication terminal 20), along with the contents shown in FIG. 18. Furthermore, the terminal 10 may display a GUI to confirm whether or not a user agrees to provide information for each of the displayed data for authentication. Alternatively, the terminal 10 may provide a button or the like that allows the user to agree to provide the list of displayed data for authentication in a batch. Note that the consent to provide data is not limited to a timing at which the screen shown in FIG. 18 is displayed (a timing at which Bluetooth (registered trademark) is prompted to be turned on), but the consent to provide the above data may be acquired at the time when biometric information is registered or at the time of a check-in procedure.

Note that utilizing location and time information is not limited to enabling the function of short-range wireless communication means such as Bluetooth (registered trademark). For example, the terminal 10 may utilize the above location and time information in confirming whether or not data stored in a digital wallet may be transmitted to the authentication terminal 20, or in prompting the user to follow a procedure for selecting data to be transmitted. For example, when the user (terminal 10) moves to a predetermined location or when a predetermined time arrives, the terminal 10 may display a GUI or the like to confirm an intention of the user to transmit the data in the digital wallet to the authentication terminal 20. Similarly, when the user moves to a predetermined location or when a predetermined time arrives, the terminal 10 may display a GUI with contents that prompts the user to select data to be transmitted to the authentication terminal 20 from among the data stored in the digital wallet.

### <Variation 3 According to the First Example Embodiment>

The above example embodiment has described a case in which the terminal 10 and the authentication terminal 20 communicate with each other using Bluetooth (registered trademark). However, the communication means for communication between the terminal 10 and the authentication terminal 20 is not a communication means with a relatively long communication distance such as Bluetooth (registered trademark), but may be a communication means with a short communication distance such as NFC (Near Field Communication). Note that when the communication means with the short communication distance, such as NFC, is used, the above first distance and the above second distance are substantially the same.

In this case, the terminal 10 of a user and the authentication terminal 20 can communicate with each other after the user arrives at the authentication terminal 20. Specifically, the terminal 10 and the authentication terminal 20 can communicate with each other when the user holds (touches) the terminal 10 over the authentication terminal 20 like a transportation system IC (Integrated Circuit) card. Therefore, the situation described using FIG. 10 (the situation in which a user does not arrive at the authentication terminal 20 in the order in which user information has been transmitted) does not occur.

Therefore, when the NFC is used, the “user identification” described above may not need to be performed. More specifically, step S13 shown in FIG. 16 may not need to be performed. However, since it is necessary to confirm legitimacy of user (identity of the owner of the terminal 10 and an authenticated person), the authentication terminal 20 may confirm the legitimacy of the user before or after the authentication processing of step S16 shown in FIG. 16.

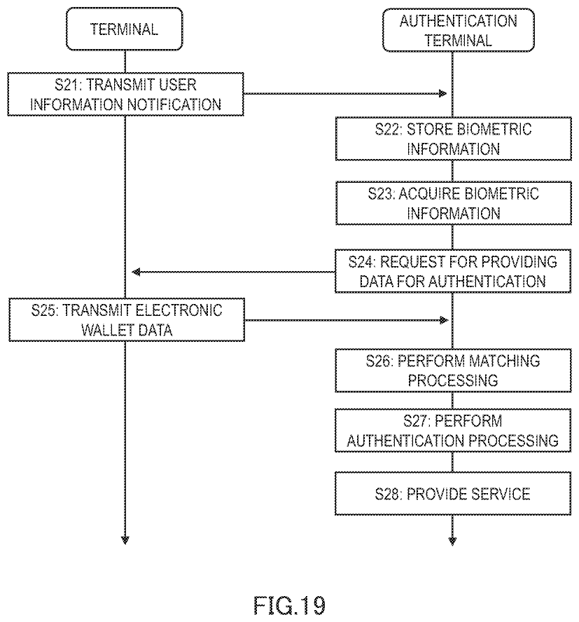

Specifically, the terminal 10 that is compatible with the NFC and the authentication terminal 20 may operate as shown in FIG. 19. FIG. 19 is a sequence diagram illustrating an example of an operation of the authentication system in variation 3 according to the first example embodiment.

The terminal 10 transmits a user information notification that includes biometric information of a user to the authentication terminal 20 (step S21).

The authentication terminal 20 stores the biometric information of the user (step S22).

The authentication terminal 20 acquires the biometric information of the user (user who holds the terminal 10 over the authentication terminal 20) who arrives at own terminal (step S23).

The authentication terminal 20 transmits a request for providing data for authentication to the terminal 10, specifying data for authentication that the terminal 10 requires to be provided (step S24).

The terminal 10 transmits the specified electronic wallet data (data for authentication) to the authentication terminal 20 (step S25).

The authentication terminal 20 (the user identification unit 304) performs a matching processing (one-to-one matching) using the biometric information acquired from the terminal 10 and the biometric information acquired in step S23 (step S26).

When the legitimacy of the user can be checked due to having been successfully authenticated by the matching processing, the authentication terminal 20 performs an authentication processing using the data for authentication (step S27). That is, the authentication terminal 20 determines the validity of the data for authentication.

When the authentication has succeeded (when the data for authentication is valid), the authentication terminal 20 provides a service to the user (step S28).

In this way, the authentication terminal 20 may successively perform the matching processing using the biometric information acquired from the terminal 10 and the authentication processing using the data for authentication.

As described above, in the authentication system according to the first example embodiment, the authentication terminal 20 requests the terminal 10 possessed by a user to provide data for authentication required to authenticate the user. The terminal 10 selects the data for authentication requested by the authentication terminal 20 from among electronic wallet data (digital data such as vaccination certificate or driver's license) stored internally as digital wallet data, and transmits the selected data for authentication to the authentication terminal 20.

The authentication terminal 20 authenticates the user based on the acquired data for authentication and provides a service. In addition, the authentication terminal 20 performs a matching processing using biometric information that the user has registered in advance in the terminal 10 and biometric information of the user who wishes to provide the service, determines that the user who has succeeded in the matching processing is legitimate owner of the terminal 10, and provides the service.

In the authentication system according to the first example embodiment, since the terminal 10 of the user automatically provides data for authentication to the authentication terminal 20, the user himself/herself does not need to select the data for authentication voluntarily. As a result, convenience for the user is improved. Furthermore, the authentication system according to the first example embodiment completes a series of authentication processing by transmitting and receiving data between the authentication terminal 20 and the terminal 10. In other words, the authentication processing is performed without using a server that stores various types of certificates, and so on. In this way, more secure authentication system is provided by performing the authentication processing by using information stored in the terminal 10 (information distributed to each terminal 10) without using the server. That is, if the server is used to store and manage certificates, and so on, of each of a plurality of users, when an information leakage occurs from the server, the certificates, and so on, of the above plurality of users are leaked, which can cause serious damage. In addition, the authentication terminal 20 can prevent an unauthorized use of the terminal 10 by performing the matching processing using biometric information of the user who owns the terminal 10 and the user who possesses the terminal 10 and wishes to receive a service. Furthermore, since the terminal 10 and the authentication terminal 20 communicate via Bluetooth (registered trademark), data for authentication is acquired in advance from a location away from the authentication terminal 20, which ensures time for processing by the authentication terminal 20.

### Second Example Embodiment

Next, a second example embodiment will be described in detail with reference to drawings.

The first example embodiment has described a case in which the terminal 10 transmits biometric information to the authentication terminal 20. The second example embodiment will describe a case in which the biometric information is transmitted from a server to the authentication terminal 20.

The following description will be made with a focus on the difference between the first example embodiment and the second example embodiment.

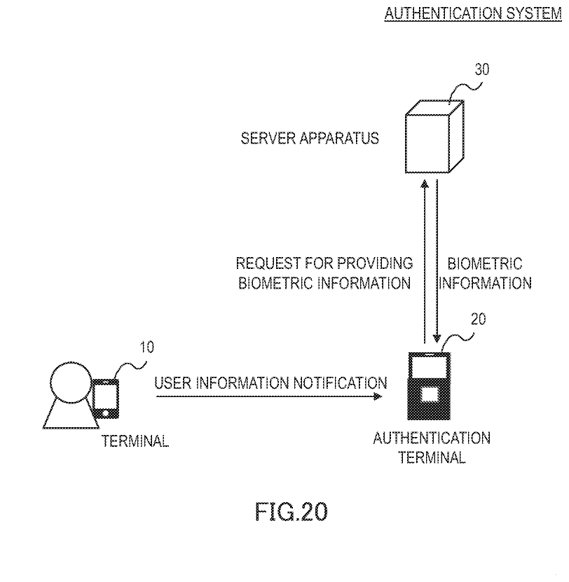

FIG. 20 is a diagram illustrating an example of a configuration of an authentication system according to the second example embodiment. As shown in FIG. 20, the authentication system according to the second example embodiment includes a server apparatus 30 in addition to a terminal 10 and an authentication terminal 20.

The server apparatus 30 stores a user ID and biometric information of a user in association with each other.

The terminal 10 according to the second example embodiment stores electronic wallet data and the user ID. However, the terminal 10 does not store the biometric information of the user. When the user who possesses the terminal 10 approaches the authentication terminal 20, the terminal 10 transmits a user information notification to the authentication terminal 20 that includes the user ID.

The authentication terminal 20 transmits a “request for providing biometric information” that includes the user ID to the server apparatus 30.

The server apparatus 30 transmits biometric information corresponding to the user ID included in the request for providing biometric information to the authentication terminal 20.

The authentication terminal 20 registers the user ID acquired from the terminal 10 and the biometric information acquired from the server apparatus 30 in the database of person to be matched in association with each other.

The subsequent operation of the terminal 10 and the authentication terminal 20 can be the same as the operation described in the first example embodiment.

Next, details of the individual apparatuses included in the authentication system according to the second example embodiment will be described.

### Terminal

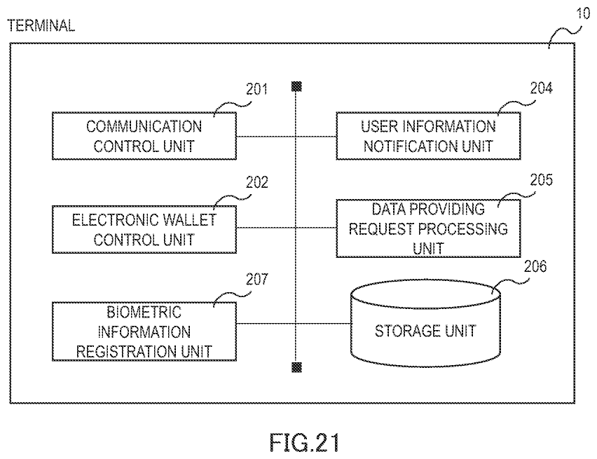

FIG. 21 is a diagram illustrating an example of a processing configuration (processing modules) of a terminal 10 according to the second example embodiment. Referring to FIG. 21, in the configuration of the terminal 10 according to the first example embodiment, the biometric information acquisition unit 203 is deleted and a biometric information registration unit 207 is added.

The biometric information registration unit 207 is means for registering biometric information of a user in the server apparatus 30. The biometric information registration unit 207 accesses the server apparatus 30 in response to operation by the user. The user information registration unit 207 inputs user ID of the user and biometric information (for example, face image) of the user to the server apparatus 30.

The user information notification unit 204 according to the second example embodiment transmits a user information notification that includes the user ID to the authentication terminal 20.

### Authentication Terminal

The processing configuration (processing modules) of the authentication terminal 20 according to the second example embodiment can be the same as the processing configuration of the authentication terminal 20 according to the first example embodiment shown in FIG. 8.

When the user information processing unit 302 according to the second example embodiment receives a user information notification from the terminal 10, the user information processing unit 302 transmits user ID included in the user information notification to the server apparatus 30. More specifically, the user information processing unit 302 transmits a request for providing biometric information that includes the user ID to the server apparatus 30.

The user information processing unit 302 receives a response to the request for providing biometric information. When the user information processing unit 302 receives a negative response, the user information processing unit 302 does not perform any special processing. When the user information processing unit 302 receives a positive response, the user information processing unit 302 stores biometric information included in the response and the user ID acquired from the terminal 10 in the database of person to be matched in association with each other.

In this way, the user information processing unit 302 according to the second example embodiment acquires biometric information of a user from the server apparatus 30 that stores biometric information of the users.

### Server Apparatus

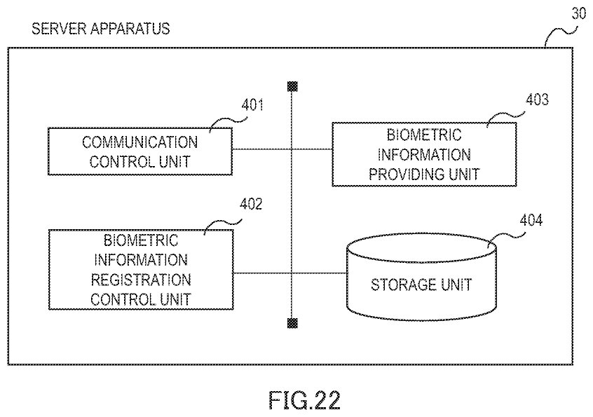

FIG. 22 is a diagram for illustrating an example of a processing configuration (processing modules) of the server apparatus 30 according to the second example embodiment. Referring to FIG. 22, the server apparatus 30 includes a communication control unit 401, a biometric information registration control unit 402, a biometric information providing control unit 403, and a storage unit 404.

The communication control unit 401 is means for controlling communication with other apparatuses. For example, the communication control unit 401 receives data (packets) from the authentication terminal 20. In addition, the communication control unit 401 transmits data to the authentication terminal 20. The communication control unit 401 gives data received from other apparatuses to other processing modules. The communication control unit 401 transmits data acquired from other processing modules to other apparatuses. In this way, other processing modules transmit and receive data to and from other apparatuses via the communication control unit 401. The communication control unit 401 includes a function as a receiving unit that receives data from other apparatuses and a function as a transmitting unit that transmits data to other apparatuses.

The biometric information registration control unit 402 is means for controlling a registration related to biometric information of a user. For example, when a user performs a predetermined action using the terminal 10 on a home page provided by the server apparatus 30, the biometric information acquisition control unit 402 acquires the user ID and biometric information of the user.

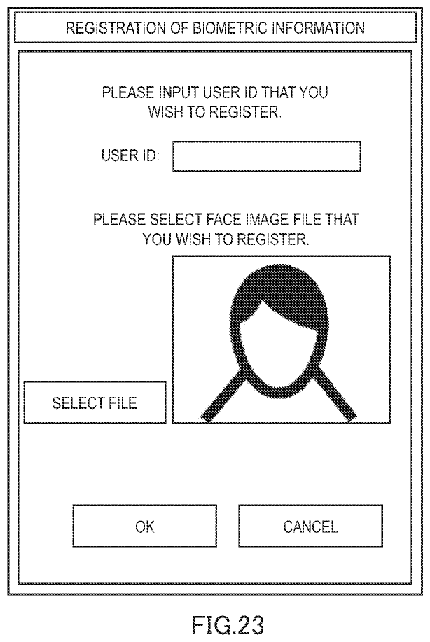

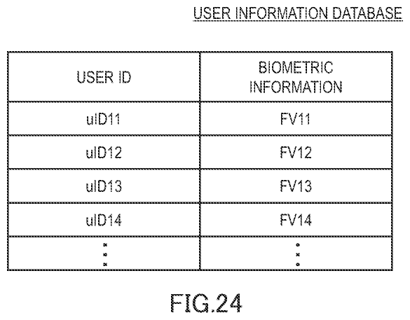

For example, the biometric information registration control unit 402 displays a GUI as shown in FIG. 23 on the terminal 10 and acquires the user ID and the biometric information (face image) of the user. The biometric information acquisition control unit 402 generates a feature value from the acquired face image. The biometric information registration control unit 402 stores the generated feature value (biometric information) and the user ID in the user information database in association with each other (see FIG. 24).

The biometric information providing control unit 403 is means for processing a request for providing biometric information from the authentication terminal 20. When the biometric information providing control unit 403 receives the request for providing biometric information, the biometric information providing control unit 403 searches the user information database using the user ID included in the request as a key, and identifies corresponding biometric information.

If the biometric information corresponding to the user ID exists, the biometric information providing control unit 403 transmits a positive response that includes the biometric information to the authentication terminal 20. If the biometric information corresponding to the user ID does not exist, the biometric information providing control unit 403 transmits a negative response indicating that fact to the authentication terminal 20.

The storage unit 404 is means for storing information necessary for the operation of the server apparatus 30. The user information database is established in the storage unit 404.

As described above, also in the second example embodiment using server apparatus 30, data for authentication necessary for authentication processing is automatically transmitted from the terminal 10 to the authentication terminal 20. As a result, the user does not have to select information himself/herself, and convenience of the user is improved.

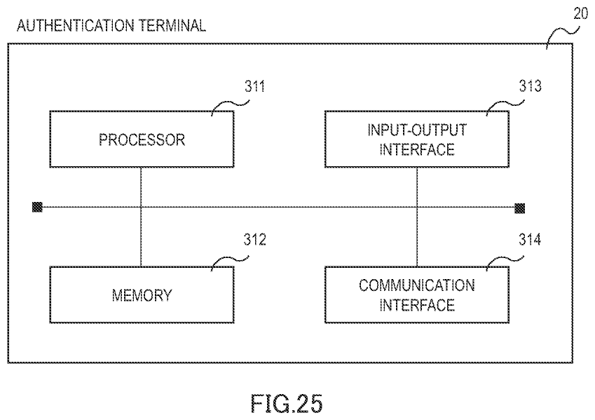

Next, a hardware configuration of an individual apparatus that constitutes the authentication system will be described. FIG. 25 is a diagram illustrating an example of a hardware configuration of the authentication terminal 20.

The authentication terminal 20 can be configured by an information processing apparatus (a so-called computer) and has a configuration illustrated as an example in FIG. 25. For example, the authentication terminal 20 includes a processor 311, a memory 312, an input-output interface 313, a communication interface 314, and so on. The components such as the processor 311 are connected to an internal bus, and so on so that these components can communicate with each other.

The hardware configuration of the authentication terminal 20 is not limited to the configuration illustrated in FIG. 25. The authentication terminal 20 may include hardware not illustrated or may be configured without the input-output interface 313 if desired. In addition, the number of components, such as the number of processors 311, included in the authentication terminal 20 is not limited to the example illustrated in FIG. 25. For example, a plurality of processors 311 may be included in the authentication terminal 20. In addition, the authentication terminal 20 may include a camera device for photographing an authenticated person and a gate apparatus or the like that restricts a user to pass through.

For example, the processor 311 is a programmable device such as a CPU (Central Processing Unit), an MPU (Micro Processing Unit), or a DSP (Digital Signal Processor). Alternatively, the processor 311 may be a device such as an FPGA (Field Programmable Gate Array) or an ASIC (Application Specific Integrated Circuit). The processor 311 executes various kinds of programs including an operating system (OS).

The memory 312 is a RAM (Random Access Memory), a ROM (Read-Only Memory), an HDD (Hard Disk Drive), an SSD (Solid State Drive), or the like. The memory 312 stores an OS program, an application program, and various kinds of data.

The input-output interface 313 is an interface for a display device and an input device not illustrated. For example, the display device is a liquid crystal display or the like. For example, the input device is a device, such as a keyboard, a mouse, or a touch panel, which receives user operations.

The communication interface 314 is a circuit, a module, or the like for performing communication with other apparatuses. For example, the communication interface 314 includes a NIC (Network Interface Card) or the like.

The functions of the authentication terminal 20 are realized by various kinds of processing modules. The processing modules are realized, for example, by causing the processor 311 to execute a program stored in the memory 312. In addition, this program can be recorded in a computer-readable storage medium. The storage medium may be a non-transient (non-transitory) storage medium, such as a semiconductor memory, a hard disk, a magnetic recording medium, or an optical recording medium. That is, the present invention can be embodied as a computer program product. In addition, the above program may be updated by downloading a program via a network or by using a storage medium in which a program is stored. In addition, the above processing modules may be realized by semiconductor chips.

As is the case with the terminal 10 and the server apparatus 30 can each be configured by an information processing apparatus, and the basic hardware configuration of the terminal 10 and the server apparatus 30 is the same as that of the authentication terminal 20. Thus, description of the basic hardware configuration of the terminal 10 and the server apparatus 30 will be omitted.

The authentication terminal 20 includes a computer and can realize its functions by causing the computer to execute a program. In addition, the authentication terminal 20 executes a control method of the authentication terminal 20 by means of the program.

### Variations

The configurations, operations, etc. of the authentication systems according to the above example embodiments are examples and do not limit the present system configuration, etc.

In the above example embodiments, the authentication terminal 20 is described as a stationary terminal, but the authentication terminal 20 may be a mobile terminal. In this case, it is assumed that emergency personnel utilize the mobile terminal (authentication terminal 20). Specifically, consider the case where a traveler from overseas (inbound passenger) is transported by an ambulance and it is difficult for the traveler and the ambulance crew to communicate in Japanese. The traveler has turned on Bluetooth (registered trademark) function on the terminal 10 that he or she possesses. The authentication terminal 20 used by the ambulance crew acquires biometric information from the terminal 10 via Bluetooth (registered trademark). The authentication terminal 20 acquires biometric information of the traveler and performs biometric authentication using a camera device of own terminal. If the biometric authentication (matching processing) has succeeded, the authentication terminal 20 acquires medical information of the traveler (for example, information on underlying diseases, whether or not the traveler has a vaccination certificate, and an expiration date of a negative PCR (Polymerase Chain Reaction) test certificate) from the terminal 10 of the traveler. The authentication terminal 20 presents the acquired medical information to the ambulance crew. The ambulance crew performs medical work based on the presented information.

Furthermore, when sensitive personal information such as medical information is handled, a mechanism is required to prevent a third party from improperly acquiring the medical information. For example, when the medical information is transmitted to the authentication terminal 20, the terminal 10 preferably emits a loud alarm or information on the authentication terminal 20 (information on a party who acquires medical information) is preferably stored in the terminal 10 as a history. In this way, since strict identity verification is required for handling medical information, the technology of the present application can be suitably applied.

The above example embodiments have described a case in which the authentication terminal 20 instructs the terminal 10 to provide one piece of data for authentication. However, the authentication terminal 20 may request for providing a plurality of data for authentication (multiple types of data for authentication) to the terminal 10. For example, the authentication terminal 20 may request the terminal 10 to provide vaccination certificate and passport. In this case, the authentication terminal 20 sets a result of authentication of user (authenticated person) as successful when the plurality of specified pieces of data for authentication can be acquired and each piece of data for authentication is valid.

The authentication terminal 20 may request the terminal 10 to provide data for authentication by rough designation, or the authentication terminal 20 may request the terminal 10 to provide data for authentication by detailed designation. For example, the authentication terminal 20 may simply request that the terminal 10 provide “credit card information” without specifying the credit card company. Alternatively, when the authentication terminal 20 requests to provide vaccination certificate, the authentication terminal 20 may request to provide the vaccine certificate by specifying type of vaccine, and the like, described in the vaccination certificate. A granularity of data for authentication (a detail of data for authentication) may be determined based on specifications, and so on, that a system administrator, or the like, requires from the authentication terminal 20.

When the request for providing data for authentication is requested by the rough designation and the plurality of electronic wallet data matching the request is stored, the terminal 10 may allow a user to select the data for authentication to be provided to the authentication terminal 20. For example, when “credit card information” is requested to be provided and plurality of credit card information is stored, the terminal 10 may generate a GUI that allows the user to select the credit card information to be provided to the authentication terminal 20 from among the plurality of credit card information.

The above example embodiments have described a case in which the authentication terminal 20 authenticates a user using data for authentication. That is, a case has been described in which the authentication terminal 20 verifies a validity of the data for authentication. However, the verification of the validity of the data for authentication may be performed by a device other than the authentication terminal 20. For example, the authentication terminal 20 may transmit the data for authentication to an external server and request the verification of the validity of the data for authentication.

The above example embodiments have described a case in which the terminal 10 and the authentication terminal 20 communicate by the same short-range wireless communication means when a distance between the terminal 10 and the authentication terminal 20 is far or close. However, the communication means used may differ according to the distance between the terminal 10 and the authentication terminal 20. Specifically, when a user goes to the authentication terminal 20 and the terminal 10 and authentication terminal 20 communicate for the first time, Bluetooth (registered trademark) may be used, and when the user arrives at the authentication terminal 20, NFC may be used. When the user arrives at the authentication terminal 20, the NFC is used to create a timing for photographing the user. That is, the authentication terminal 20 may acquire biometric information of the user when the authentication terminal 20 starts communicating with the terminal 10 using the NFC.

The above example embodiments have described a case in which the terminal 10 and the authentication terminal 20 communicate via Bluetooth (registered trademark). At that time, the authentication terminal 20 may transmit and receive Bluetooth (registered trademark) radio wave using transmitter and receiver that has no restrictions on a location for installation. Specifically, the transmitter and receiver may be installed at a location farther than communication distance of the Bluetooth (registered trademark), and the authentication terminal 20 may communicate with the terminal 10 using the transmitter and receiver.

The above example embodiments have described a case in which the authentication terminal 20 requests the terminal 10 to provide data for authentication after a matching processing of a user has succeeded. However, the authentication terminal 20 may request the terminal 10 to provide the data for authentication in response to that the authentication terminal 20 has received a user information notification. In this case, the authentication terminal 20 may determine a validity of the data for authentication as soon as the authentication terminal 20 has acquired the data for authentication, and store the result of authentication in the database of person to be matched. By taking these actions, the authentication terminal 20 performs the matching processing using biometric information when the user has arrived at the authentication terminal 20, and can obtain the result of authentication as soon as the result of the matching processing using biometric information is obtained.

The above example embodiments have described a case in which the authentication terminal 20 performs 1-to-N authentication using biometric information of a user who has arrived at own terminal and biometric information stored in the database of person to be matched. However, the authentication terminal 20 may also perform one-to-one authentication using the biometric information of the user on the assumption that the user arrives at own terminal in the order in which the user information notifications are transmitted. In this case, the authentication terminal 20 may perform one-to-one authentication using the biometric information acquired when the user has arrived at own terminal and biometric information stored most recently in the database of person to be matched, and may check legitimacy with respect to a possessor of the terminal 10. Note that the authentication terminal 20 deletes the entry used for the matching processing in the database of person to be matched after the authentication processing is performed. In this way, an accuracy of authentication is improved by checking the legitimacy of the possessor of the terminal 10 through one-to-one authentication.

In the second example embodiment, the authentication terminal 20 may not perform a biometric authentication (matching processing using biometric information), but the server apparatus 30 may perform the matching processing. In this case, the authentication terminal 20 acquires biometric information of a user who has arrived at own terminal and transmits the acquired biometric information to the server apparatus 30. The server apparatus 30 transmits user ID of the user identified by the matching processing to the authentication terminal 20. The authentication terminal 20 determines that legitimacy regarding a possessor of the terminal 10 has been checked in response that the authentication terminal 20 had received the user ID.

The authentication terminal 20 (the user information processing unit 302) may access the database of person to be matched periodically or at predetermined timing and delete entries that have been registered for a predetermined period of time.

In the above example embodiments, as described with reference to FIG. 4, or the like, a case has been described in which the authentication terminal 20 requests for providing data for authentication to the terminal 10, after a user holding the terminal 10 arrives at the authentication terminal 20 and biometric information (face image) of the user who arrives at the terminal 20 has been acquired. However, the authentication terminal 20 may request for providing data for authentication to the terminal 10 before the user arrives at own terminal.

The terminal 10 may transmit a user information notification that includes information about a service that a user desires to use to the authentication terminal 20. For example, the terminal 10 may transmit a user information notification that includes type of flight (domestic flight, international flight) that the user is boarding to the authentication terminal 20. The authentication terminal 20 may change data for authentication that the authentication terminal 20 requests based on acquired information on the service that the user desires to be provided. For example, for the user using the domestic flight, the authentication terminal 20 requests that membership information of an airline company be provided. On the other hand, for the user using the international flight, the authentication terminal requests that the airline membership information of the airline company and vaccination certificate be provided. In this way, even for the same authentication terminal 20, contents (type of data for authentication) to request for providing by the request for providing data for authentication may be changed for each service that the user wishes to receive.

The above example embodiments have described a case in which the authentication terminal 20 requests the terminal 10 to provide data for authentication in response that the authentication terminal 20 has received a user information notification from the terminal 10. That is, the above example embodiments have described a case in which the terminal 10 first transmits data (user information notification) to the authentication terminal 20. However, the authentication terminal 20 may also transmit the data to the terminal 10 first. For example, when the authentication terminal 20 starts communication with the terminal 10, the authentication terminal 20 transmits a “request for providing biometric information and data for authentication” to the terminal 10. In response to this request, the terminal 10 transmits biometric information and data for authentication (type of data specified by the authentication terminal 20) to the authentication terminal 20. At that time, terminal 10 may display a GUI to obtain a consent of the user to transmit the specified data from the authentication terminal 20, or a GUI to select data to be transmitted to the authentication terminal 20 from among a plurality of data. In other words, the terminal 10 may check an intention of the user using the GUI for “consent to provide data” or “selection of data to transmit” in response that the terminal 10 has received the “request for providing biometric information and data for authentication” from the authentication terminal 20.

The terminal 10 and authentication terminal 20 may communicate with each other by means other than Bluetooth (registered trademark). For example, the terminal 10 and the authentication terminal 20 may communicate with each other using ZigBee (registered trademark) or the like. Alternatively, the terminal 10 and authentication terminal 20 may communicate with each other by a standard compatible with wireless LAN (Local Area Network).

The above example embodiments have described a case in which the database of person to be matched is established inside the authentication terminal 20, but the database of person to be matched may be established on an external database server or the like. That is, some functions of the authentication terminal 20 may be implemented in another server. More specifically, the “user identification unit (user identification means)”, “authentication processing unit (authentication processing means)”, and so on, described above may be implemented in any of the apparatuses included in the system.

The above example embodiments have described a case in which a feature value generated from a face image is transmitted as biometric information from the terminal 10 to the authentication terminal 20. However, a face image may also be transmitted from the terminal 10 to the authentication terminal 20 as the biometric information. In this case, the authentication terminal 20 may generate the feature value from the face image and register the feature value in the database of person to be matched.

While the data exchange between the terminal 10, authentication terminal 20, and server apparatus 30 is not limited to any particular mode, data exchanged between these apparatuses may be encrypted. It is desirable that the biometric information and so on are transmitted and received between these apparatuses and encrypted data is transmitted and received in order to properly protect this information.

In the flowcharts and sequence diagrams used in the above description, a plurality of steps (processes) are sequentially described. However, the order of the execution of the steps performed in the individual example embodiment is not limited to the described order. In the individual example embodiment, the order of the illustrated steps may be changed to the extent that a problem is not caused on the contents of the individual example embodiment. For example, individual processes may be executed in parallel.

The above example embodiments have been described in detail to facilitate the understanding of the present application disclosed and not to mean that all the configurations described above are needed. In addition, if a plurality of example embodiments have been described, each of the example embodiments may be used individually or a plurality of example embodiments may be used in combination. For example, part of a configuration according to one example embodiment may be replaced by a configuration according to another example embodiment. For example, a configuration according to one example embodiment may be added to a configuration according to another example embodiment. In addition, addition, deletion, or replacement is possible between part of a configuration according to one example embodiment and another configuration.

The industrial applicability of the present invention has been made apparent by the above description. That is, the present invention is suitably applicable, for example, to authentication systems and the like that authenticate users.

A part or the entirety of the example embodiments described above may be described as in the following supplementary notes, but is not limited to the followings.

### [Supplementary Note 1]

An authentication terminal, including:
a first acquisition unit that acquires first biometric information of a user from another apparatus when a distance between own terminal and the user reaches a first distance;
a second acquisition unit that acquires second biometric information of the user when the distance between the own terminal and the user reaches a second distance;
a control unit that performs control to acquire data for authentication from a terminal possessed by the user, which is necessary to determine whether or not to provide a service to the user; and
an authentication processing unit that determines that an authentication processing of the user is successful when a result of a matching processing using the first biometric information and the second biometric information is successful and the data for authentication acquired from the terminal is valid.

### [Supplementary Note 2]

The authentication terminal according to supplementary note 1, wherein the first acquisition unit acquires the first biometric information from the terminal.

### [Supplementary Note 3]

The authentication terminal according to supplementary note 2, further including a user identification unit that performs the matching processing using the first biometric information and the second biometric information.

### [Supplementary Note 4]

The authentication terminal according to supplementary note 3, wherein the control unit specifies the data for authentication when the user identification unit succeeds in the matching processing, and requests the terminal to provide the specified data for authentication.

### [Supplementary Note 5]

The authentication terminal according to any one of supplementary note 1 to 4, further including a task execution unit that outputs messages according to the result of the authentication processing.

### [Supplementary Note 6]

The authentication terminal according to supplementary note 1, wherein the first acquisition unit acquires the first biometric information from a server apparatus that stores the first biometric information of the user.

### [Supplementary Note 7]

The authentication terminal according to any one of supplementary notes 1 to 6, wherein the control unit communicates the terminal by means of short-range wireless communication.

### [Supplementary Note 8]

The authentication terminal according to any one of supplementary notes 1 to 7, wherein the biometric information is a face image or a feature value generated from the face image.

### [Supplementary Note 9]

A system, including:
a terminal possessed by a user; and
an authentication terminal,
wherein the authentication terminal including a first acquisition unit that acquires first biometric information of a user from another apparatus when a distance between own terminal and the user reaches a first distance;
a second acquisition unit that acquires second biometric information of the user when the distance between the own terminal and the user reaches a second distance;
a control unit that performs control to acquire data for authentication from a terminal possessed by the user, which is necessary to determine whether or not to provide a service to the user; and an authentication processing unit that determines that an authentication processing of the user is successful when a result of a matching processing using the first biometric information and the second biometric information is successful and the data for authentication acquired from the terminal is valid.

### [Supplementary Note 10]

The system according to supplementary note 9, wherein the terminal transmits the first biometric information to the authentication terminal when the terminal starts communication with the authentication terminal by means of a short-range wireless communication.

### [Supplementary Note 11]

The system according to supplementary note 10, wherein the terminal prompt the user to enable the short-range wireless communication when a distance between the terminal and the authentication terminal reaches a third distance.

### [Supplementary Note 12]

The system according to any one of supplementary notes 9 to 11, wherein the control unit specify the data for authentication and request to provide the specified data for authentication to the terminal, and wherein the terminal acquire consent from the user to provide the specified data for authentication to the authentication terminal.

### [Supplementary Note 13]

A control method of an authentication terminal, the control method including:
acquiring first biometric information of a user from another apparatus when a distance between own terminal and the user reaches a first distance;
acquiring second biometric information of the user when the distance between the own terminal and the user reaches a second distance;
performing control to acquire data for authentication from a terminal possessed by the user, which is necessary to determine whether or not to provide a service to the user; and
determining that an authentication processing of the user is successful when a result of a matching processing using the first biometric information and the second biometric information is successful and the data for authentication acquired from the terminal is valid.

### [Supplementary Note 14]

A computer-readable storage medium, storing a program causing a computer mounted on an authentication terminal to perform processing for:
acquiring first biometric information of a user from another apparatus when a distance between own terminal and the user reaches a first distance;
acquiring second biometric information of the user when the distance between the own terminal and the user reaches a second distance;
performing control to acquire data for authentication from a terminal possessed by the user, which is necessary to determine whether or not to provide a service to the user; and
determining that an authentication processing of the user is successful when a result of a matching processing using the first biometric information and the second biometric information is successful and the data for authentication acquired from the terminal is valid.

The entire disclosure of the above patent literature is incorporated herein by reference thereto. While the example embodiments of the present invention have thus been described, the present invention is not limited to these example embodiments. It is to be understood to those skilled in the art that these example embodiments are only examples and that various variations are possible without departing from the scope and sprit of the present invention. That is, the present invention of course includes various variations and modifications that could be made by those skilled in the art in accordance with the overall disclosure including the claims and the technical concept.

### REFERENCE SIGNS LIST

10 terminal
20 authentication terminal
20-1 authentication terminal
20-2 authentication terminal
20-3 authentication terminal
30 server apparatus
100 authentication terminal
101 first acquisition unit
102 second acquisition unit
103 control unit
104 authentication processing unit
201 communication control unit
202 electronic wallet control unit
203 biometric information acquisition unit
204 user information notification unit
205 data providing request processing unit
206 storage unit
207 biometric information registration unit
301 communication control unit
302 user information processing unit
303 biometric information acquisition unit
304 user identification unit
305 authentication data control unit
306 authentication processing unit
307 task execution unit
308 storage unit
311 processor
312 memory
313 input-output interface
314 communication interface
401 communication control unit
402 biometric information registration control unit
403 biometric information providing unit
404 storage unit

What is claimed is:

1. An authentication terminal, comprising:
at least one memory storing a set of instructions; and
at least one processor configured to execute the set of instructions to:
acquire first biometric information of a user from another apparatus when a distance between own terminal and the user reaches a first distance;
acquire second biometric information of the user when the distance between the own terminal and the user reaches a second distance;
perform control to acquire data for authentication from a terminal possessed by the user, which is necessary to determine whether or not to provide a service to the user; and
determine that an authentication processing of the user is successful when a result of a matching processing using the first biometric information and the second biometric information is successful and the data for authentication acquired from the terminal is valid.

2. The authentication terminal according to claim 1, wherein
the at least one processor is further configured to execute the set of instructions to acquire the first biometric information from the terminal.

3. The authentication terminal according to claim 2, wherein
the at least one processor is further configured to execute the set of instructions to perform the matching processing using the first biometric information and the second biometric information.

4. The authentication terminal according to claim 3, wherein
the at least one processor is further configured to execute the set of instructions to specify the data for authentication when the matching processing is successful, and request the terminal to provide the specified data for authentication.

5. The authentication terminal according to claim 1, wherein
the at least one processor is further configured to execute the set of instructions to output messages according to the result of the authentication processing.

6. The authentication terminal according to claim 1, wherein
the at least one processor is further configured to execute the set of instructions to acquire the first biometric information from a server apparatus that stores the first biometric information of the user.

7. The authentication terminal according to claim 1, wherein
the at least one processor is further configured to execute the set of instructions to communicate the terminal by means of short-range wireless communication.

8. The authentication terminal according to claim 1, wherein the biometric information is a face image or a feature value generated from the face image.

9. A system, comprising:
a terminal possessed by a user; and
an authentication terminal,
wherein the authentication terminal comprising:
at least one memory storing a set of instructions; and
at least one processor configured to execute the set of instructions to:
acquire first biometric information of a user from another apparatus when a distance between own terminal and the user reaches a first distance;
acquire second biometric information of the user when the distance between the own terminal and the user reaches a second distance;
perform control to acquire data for authentication from a terminal possessed by the user, which is necessary to determine whether or not to provide a service to the user; and
determine that an authentication processing of the user is successful when a result of a matching processing using the first biometric information and the second biometric information is successful and the data for authentication acquired from the terminal is valid.

10. The system according to claim 9, wherein the terminal transmits the first biometric information to the authentication terminal when the terminal starts communication with the authentication terminal by means of a short-range wireless communication.

11. The system according to claim 10, wherein the terminal prompt the user to enable the short-range wireless communication when a distance between the terminal and the authentication terminal reaches a third distance.

12. The system according to claim 9, wherein
the at least one processor is further configured to execute the set of instructions to specify the data for authentication and request to provide the specified data for authentication to the terminal, and
wherein the terminal acquire consent from the user to provide the specified data for authentication to the authentication terminal.

13. A control method of an authentication terminal, the control method comprising:
acquiring first biometric information of a user from another apparatus when a distance between own terminal and the user reaches a first distance;
acquiring second biometric information of the user when the distance between the own terminal and the user reaches a second distance;
performing control to acquire data for authentication from a terminal possessed by the user, which is necessary to determine whether or not to provide a service to the user; and
determining that an authentication processing of the user is successful when a result of a matching processing using the first biometric information and the second biometric information is successful and the data for authentication acquired from the terminal is valid.

14. (canceled)
